(19) United States
(12) Patent Application Publication
(10) Pub. No.: US 2021/0387793 A1
(43) Pub. Date: Dec. 16, 2021

(54) DETERGENT ARTICLES DISPENSER

(71) Applicant: The Procter & Gamble Company, Cincinnati, OH (US)

(72) Inventor: Lucresse Gemma Van Wonterghem, Edegem (BE)

(21) Appl. No.: 17/345,397

(22) Filed: Jun. 11, 2021

(30) Foreign Application Priority Data
Jun. 12, 2020 (EP) 20179691.9

(51) Int. Cl. B65D 83/06; B65D 83/00

(52) U.S. Cl. CPC B65D 83/06; B65D 83/0083

(57) ABSTRACT

A system that includes detergent articles and a dispenser. The dispenser may include a drum containing the articles, a collection element having a scoop, and a refilling area. The drum may be rotatable around a drum rotation axis making an angle of at least 75 degrees and of less than 135 degrees with the direction of gravity, and the drum may have a cylindrical shape, a barrel shape, a funnel shape or a conical shape.

### FIELD OF THE INVENTION

The present disclosure relates to systems for dispensing articles, such as detergent articles. The system can include a rotatable drum.

### BACKGROUND OF THE INVENTION

This description generally relates to the dispensing of detergent articles, in particular to such dispensing to end consumers in detergent articles point of sales such as shops or supermarkets. While detergent articles may be acquired by end consumers as a packaged product comprising a specific number of detergent articles enclosed in a sealed container, in some instances end consumers may wish to use a reusable container in order to reduce waste produced by packaging material. In such cases, detergent articles may be dispensed from a bulk detergent articles dispenser into a refilling area.

There is a need for efficient systems that can dispense such articles.

### SUMMARY OF THE INVENTION

The present disclosure relates to a system that includes articles and a dispenser for the articles, the articles being detergent articles, the dispenser including: a drum containing the articles, the drum being rotatable around a drum rotation axis making an angle of at least about 75 degrees and of less than about 135 degrees with the direction of gravity; a collection element, the collection element being rotatable around the drum rotation axis, the collection element including a scoop, the scoop permitting collecting and lifting at least one article as the scoop rotates from a collecting position to a releasing position; and a refilling area, whereby an article collected and lifted by the scoop is directed from the releasing position to the refilling area.

### BRIEF DESCRIPTION OF THE DRAWINGS

FIG. 1A-C illustrate a first view of an example system.

FIG. 2 A-C illustrate a second view of the example system of FIG. 1A-C.

FIG. 3 illustrates another example system.

FIG. 4 illustrates a further example system.

FIG. 5 illustrates a first view of another example system.

FIG. 6 illustrates a second view of the example system of FIG. 5.

FIG. 7 illustrates a first view of yet another example system.

FIG. 8 illustrates a second view of the example system of FIG. 7.

FIG. 9 illustrates a first view of yet a further example system.

FIG. 10 illustrates a second view of the example system of FIG. 9.

FIG. 11A-B illustrate an example scoop and detergent article.

### DETAILED DESCRIPTION OF THE INVENTION

This description relates to a system comprising articles and a dispenser for the articles, the articles being detergent articles. The system according to this description permits a controlled dispensing of the articles, in particular avoiding such articles getting dispensed in an unpredictable quantity, avoiding such articles from being damaged, and avoiding jamming of the dispenser.

A dispenser according to this description may also have a beneficial environmental impact by enabling improved transport logistics, from supply chain efficacy to manufacturer and points of sales, for example by permitting using bulk packaging presenting a reduced less air space and packaging material space, resulting in a reduction of means of transportation for transporting a same number of articles. Such compactness advantages may also result in an improved shelf occupancy in points of sale, permitting presenting an increased number of articles per square meter shelf space. Other benefit may include a reduced time spent by shop assistant to fill shelves, for example by using or plugging in a refill cartridge to refill a dispenser according to this description, in lieu of stacking numerous boxes. Less space may also be occupied in warehouse by using a combination of bulk storage and of a dispenser according to this description.

The articles are detergent articles. Detergent articles should be understood as articles comprising a detergent product. Detergent products should be understood in this disclosure as products comprising a surfactant. Detergent products may also comprise a bleach or other ingredients. Example detergent product compositions are described in more detail herein. In some examples, the detergent product comprises unit dose detergent pouches. Example unit dose detergent pouches are described in more detail herein.

Detergent articles are in some cases unit dose articles containing a liquid detergent, a granular detergent, or a combination of a liquid detergent and of a granular detergent, in which cases damaging the detergent article may produce undesired leakage of detergent, contamination of other articles, of the dispenser, or of surroundings of the dispenser.

Detergent articles may in some cases be prone to jamming when in bulk, particularly when detergent articles are flexible unit dose articles, the flexibility increasing the risk of jamming, the flexible unit dose articles tending to compact against each other to produce a mass of jammed articles. The risk of jamming may be even further when the articles are flexible water soluble unit dose articles, the flexibility and water solubility further increasing the risk of jamming water solubility in particular can be related to a certain degree of “stickiness” of the detergent articles, such stickiness further increasing a risk of the articles tending to compact against each other.

Detergent articles may in some cases be particularly difficult to handle in a predictable and quantifiable manner, in particular when detergent articles have a shape factor resulting in the detergent articles offering a particularly large external surface of contact compared to their volume. In other words, it is more difficult to handle “longer” or “thinner” detergent articles, compared to, for example, sphere like articles.

Detergent articles may in some cases take the form of side by side pouches (as compared to superposed pouches), whereby a connecting seal area between side by side compartments of a same pouch may act as a foldable space allowing individual pouches to bend versus each other, leading to a variation of overall pouch shapes within bulk containers making it more difficult to fit a scoop, for example due to some side by side pouches being straight or flat, while other side by side pouches having a reduced and acute angle between side compartments, yet other pouches having a larger obtuse angle between the side compartments, further side by side pouches having a separating seal area between side compartments stretched out, yet further side by side pouches being compressed such that side by side compartments touch each other. Such side by side pouches thereby have a limited overall shape or shape factor consistency, in particular compared to superposed compartment pouches which maintain a substantially more spherical shape factor when in bulk, such consistency in shape factor facilitating the fitting within a scoop.

These and other characteristics of detergent articles therefore lead to designing a specific dispenser, leading to a system according to this description, and permitting controlled refilling of detergent articles, thereby fomenting a use of reusable detergent article containers, leading to a positive environmental impact and consumer satisfaction.

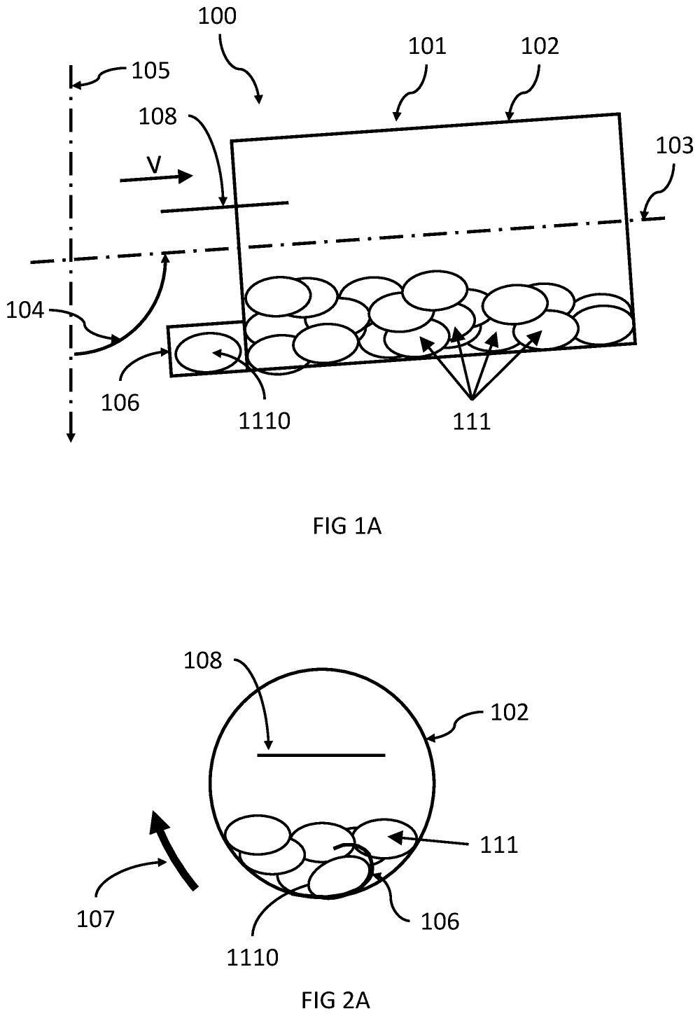

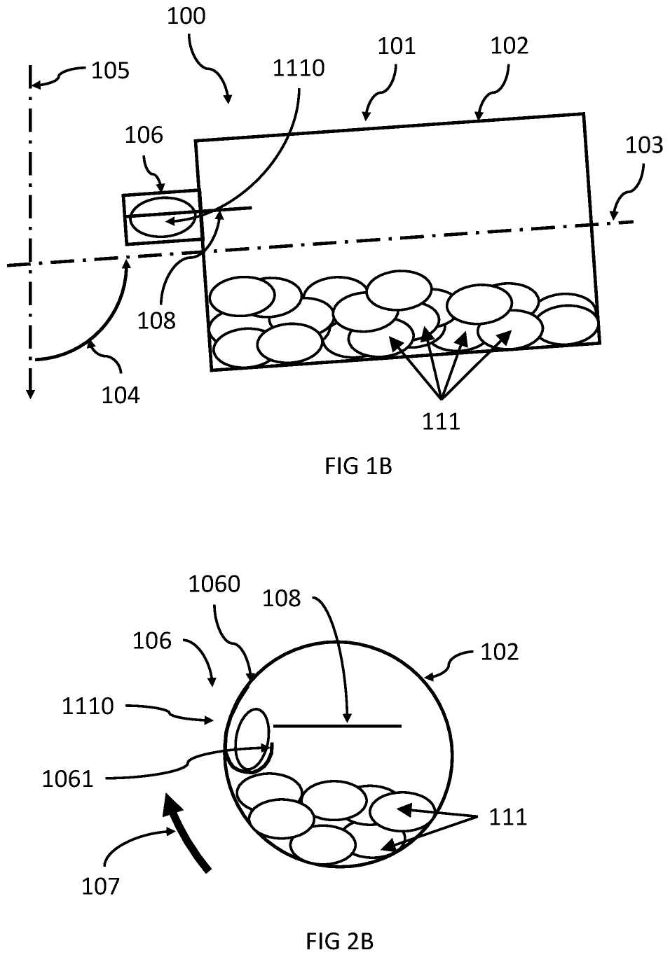

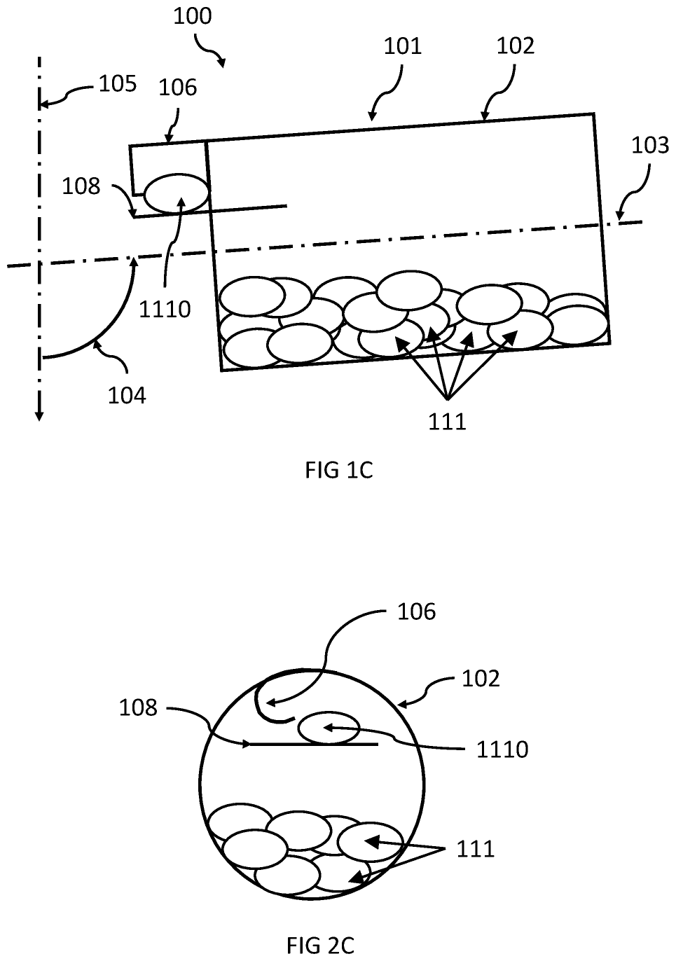

FIGS. 1A and 2A illustrate an example system 100 comprising articles 111 and a dispenser 101 for the articles 111, the articles 111 being detergent articles. FIG. 2A corresponds to a view along direction V as illustrated in FIG. 1A. The system according to this disclosure should be understood as comprising both the dispenser and the articles, the dispenser being adapted to dispense such articles being detergent articles. The dispenser should be understood as an apparatus permitting dispensing detergent articles in a controlled manner. While a dispenser may be suitable for dispensing articles which may not be detergent articles, it was found that the specific dispenser according to the system of this disclosure was particularly suitable for dispensing detergent articles, leading to the system according to this disclosure. A given dispenser may be progressively emptied from detergent articles as detergent articles are being dispensed, in which case such dispenser may be replenished by refilling the dispenser with detergent articles for further dispensing as a system according to this disclosure. In some examples, a system according to this disclosure comprises, when full, more than 100 detergent articles. In some examples, a system according to this disclosure comprises, when full, more than 200 detergent articles. In some examples, a system according to this disclosure comprises, when full, from 250 detergent articles and up to 1000 detergent articles. In some examples, the detergent articles comprised in the system according to this disclosure each are of the same nature and shape.

The dispenser such as example dispenser 101 comprises a drum 102 containing the articles 111. A drum according to this disclosure should be understood as a container suitable to contain a significant number of detergent articles, for example more than 100 detergent articles. A drum may be a hollow container made for example out of metal, plastic, cardboard or wood material. The drum 102 is rotatable around a drum rotation axis 103 (parallel to the direction V illustrated in FIG. 1A) making an angle 104 of at least 75 degrees and of less than 135 degrees with the direction of gravity 105. The fact that the drum is rotatable around a drum rotation axis permits generating a movement of the content of the drum, in other words generating a movement of the detergent articles through drum rotation. The angle between the drum rotation axis and the direction of gravity was found to permit obtaining such movement while avoiding compaction of the content of the drum due to gravity force. The configuration of the rotatable drum according to this disclosure permits submitting each article to both gravity and to a force resulting from rotation of the drum, whereby the combination of gravity and of the force resulting from the rotation of the drum permit a movement of the detergent articles in the drum which avoids jamming the dispenser. In order to facilitate rotation of the drum, the drum preferably has either a cylindrical shape, a barrel shape, a funnel shape or a conical shape. The drum 102 represented in FIG. 1 has a cylindrical shape. Such shapes facilitate unhindered movement of the detergent articles as the drum rotates, thereby participating in avoiding jamming. In some examples, the drum rotation axis makes an angle of at least 80 degrees and of less than 110 degrees with the direction of gravity. In some examples, the drum rotation axis makes an angle of at least 85 degrees and of less than 95 degrees with the direction of gravity. An angle closer to 90 degrees avoids jamming by reducing the impact of gravity. An angle slightly higher than (i.e. superior to) 90 degrees permits for example using gravity to contribute to directing detergent articles towards the collection element, while maintaining the risk of jamming at an acceptable level. An angle slightly lower than 90 degrees will further reduce the risk of jamming.

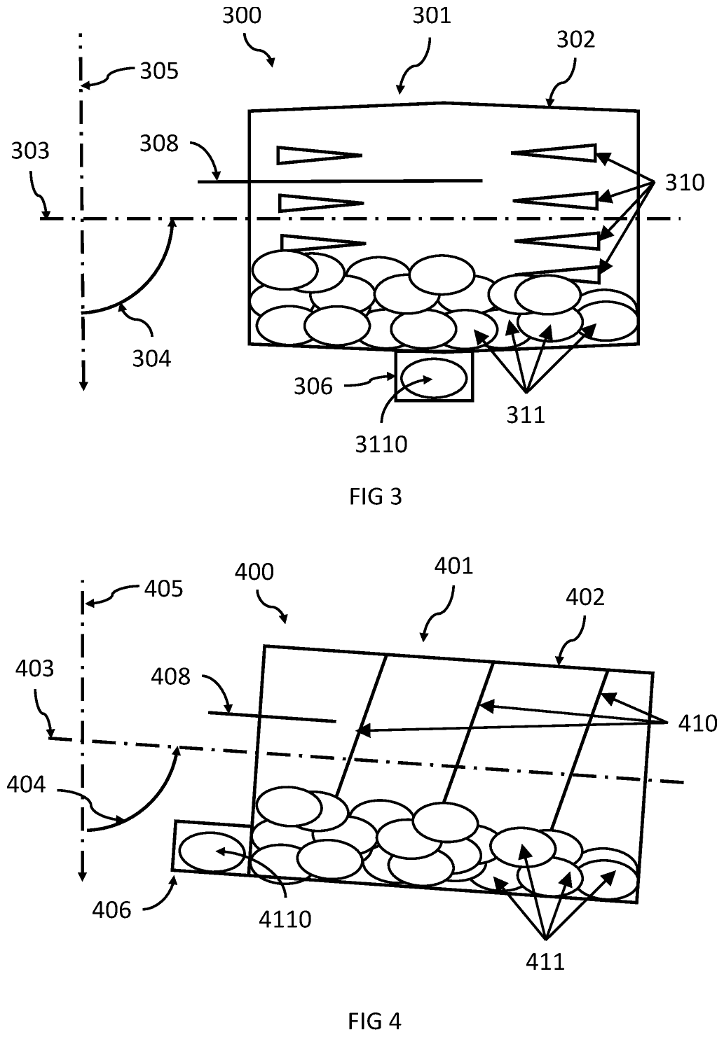

The dispenser such as example dispenser 101 comprises a collection element 106, the collection element 106 being rotatable around the drum rotation axis 103, for example following the direction indicated by arrow 107, the collection element 106 comprising a scoop, the scoop permitting collecting and lifting at least one article as the scoop rotates from a collecting position illustrated in FIGS. 1A and 2A to a releasing position illustrated in FIGS. 1C and 2C. FIGS. 1B and 2B represent a position intermediate between the collecting position and the releasing position. The collection element according to this disclosure should be understood as a mechanical element comprising a collecting cavity configured to collect one or more detergent articles, preferably a single detergent article, from the drum when in the collecting position. The positioning of the collection element in relationship with the drum may take different configurations. In some configurations, the collection element extends away from an external radius of the drum in relation to the drum rotation axis (in other words, the collection element may be located “below” the drum when in the collecting position, as for example in FIG. 3). In other examples, the collection element may extend away from the drum along the rotation axis, while not extending away from an external radius of the drum (in other word, the collection element may be located on a side of a drumhead when in the collecting position, as for example in FIG. 1A). The positioning of the collection element in relationship with the drum may be a function of the angle of the drum rotation axis with gravity, whereby a side position of the collecting element compared to a below position of the collecting element world reduce the effect of gravity and therefore of jamming collection is facilitated by the detergent articles being submitted to the combination of gravity and of rotation movement of the drum. Other forces may be applied to the detergent articles to direct them towards the collecting element, such as a paddle or article guide as per the present description. In some examples, collection is further facilitated by vibration. In some examples, the collecting position corresponds to the collection element substantially located at a bottom position using the referential defined by gravity. The lifting of one or more detergent articles from the collecting position to the releasing position takes place between a collecting position located lower than the releasing position. While illustrated as being positioned at the top of the drum, the releasing position may be positioned at different angles around the drum, for example on a side of the drum. While illustrated as being positioned below the drum, the collecting position may be positioned at different angles around the drum, for example on a side of the drum, thereby reducing a risk of jamming.

The collection element 106 is according to this disclosure rotatable around the drum rotation axis 103. In some examples, the collection element is configured to rotate at the same speed as the drum. A configuration whereby the collection element is configured to rotate at the same speed as the drum may facilitate construction of the dispenser, whereby the rotation movement of the drum aiming at directing the detergent articles towards the collection element when the collection element is in the collecting position also directs the movement of the collection element from the collecting position to the releasing position and back to the collecting position. In some examples whereby the collection element is configured to rotate at the same speed as the drum, the collection element is integral to the drum. Making the collection element integral to the drum may facilitate manufacturing of the dispenser by reducing a number of pieces.

In other examples the collection element is configured to rotate faster than the drum, the collection element being a part separate from the drum, the collection element being engaged with the drum. Configuring the collection element to rotate faster than the drum may accelerate dispensing while providing sufficient movement of the drum to direct detergent articles towards the collection element when the collection element is in the collecting position. A comparatively reduced rotation speed of the drum may avoid submitting the detergent articles to forces which would otherwise heighten a risk of breakage or rupture of the detergent articles in the drum, while a comparatively increased rotation speed of the collection element would accelerate dispensing of the detergent articles and thereby increase customer satisfaction. Engagement of the collection element with the drum may in such a case permit relative rotation between the collection element and the drum around the drum rotation axis. In some examples, a lower rotation speed of the drum may be preferable during operation, in particular in a case where the drum is rotated manually, i.e. exclusively by human muscular force, in order to involve a less force of a user in view of a weight produced by the number of articles located in the drum.

The collection element comprises a scoop. A scoop should be understood as a mechanical element comprising a pocket like cavity sized to house one or more detergent articles. In some cases, a scoop cavity is sized to house a single detergent article. In some cases, a scoop is sized to house two detergent articles. The scoop cavity should be shaped so as to retain a content of the scoop cavity while moving from the collecting position to the releasing position, and shaped so as to release the content when in the releasing position.

In some cases, the scoop comprises a cavity wall having a continuously increasing radius of curvature defining a first intersection 1060 between the scoop and the drum and a second intersection 1061 between the scoop and the drum as illustrated for example in FIG. 2B, the scoop cavity defining an opening between the first intersection and the second intersection, such opening permitting passage of the one or more detergent articles from the drum to the scoop, the first intersection preceding the second intersection when the collection element rotates from the collecting position to the releasing position, the first intersection making a first angle with a wall of the drum and the second intersection making a second angle with the wall of the drum, the first angle being an acute angle of less than 90 degrees, preferably less than 60 degrees, and the second angle being an obtuse angle of more than 90 degrees, preferably more than 120 degrees, such different angles being defined by the continuously increasing radius of curvature and permitting both maintaining the one or more detergent articles in the spoon from the collecting position to the releasing position and release of the same when in the releasing position. In some examples, the first angle is an acute angle of more than 45 degrees in order to limit a risk of a detergent article getting stuck in the scoop. In some examples the second angle is an obtuse angle of less than 135 degrees in order to limit a risk of a detergent article getting stuck in the scoop.

The dispenser such as example dispenser 101 comprises a refilling area 108, whereby an article 1110 collected, as illustrated in FIGS. 1A and 2A, and lifted, as illustrated in FIGS. 1A and 2B, by the scoop is directed from the releasing position to the refilling area 108 as illustrated in FIGS. 1C and 2C. The refilling area may in some examples comprise a plate. The refilling area may in some examples be located within the drum. The refilling area may in some examples be located outside of the drum. The refilling area should be understood as an area towards which the detergent articles are directed once released from the collection element. The refilling area permits separating detergent articles collected, lifted and released by the collection element from other detergent articles remaining in the drum and which have not been collected yet by the collection element.

In the example illustrated in FIGS. 1A-C and FIGS. 2A-C, the collection element is adjacent to a drum opening at a drumhead. In this case, the drumhead adjacent to the collection element is a drumhead located slightly below an opposite drumhead of the drum due to the drum rotation axis being inclined whereby the angle 104 in this case differs from 90 degrees. This may for example facilitate capturing detergent articles into the collection element by directing such detergent articles towards the drumhead which is situated lower. Other configurations may be considered.

FIG. 3 illustrates another example system 300 according to this disclosure. The system comprises dispenser 301, drum 302 rotatable around drum rotation axis 303 making in this example an angle 304 of about 90 degrees with a direction of gravity 305. In the system 300 according to FIG. 3, the collection element 306 is located in an area situated between drumheads, in this case substantially half way between drumheads. In this example drum 302 has a barrel shape and comprises a central portion having a diameter larger than a diameter of the drum at drum heads, the collection element being located adjacent to the larger diameter portion. The collection element may collect a detergent article such as detergent article 3110 from the detergent articles 311 contained in drum 302. The collection element may rotate in order to lift and release detergent article 3110 onto refilling area 308. In this example, the drum comprises an article guide 310 for guiding the articles towards the collection element 306. The article guide is comprised in a drum shell of the drum, the drum shell forming drum walls between drum ends, drum head being substantially normal to the drum rotation axis. In this example, the article guide comprises a plurality of protrusions on an internal wall of the drum, the protrusions guiding the detergent articles towards the collection element. Other configurations may be considered, comprising for example a single protrusion. In another example, the article guide may comprise one or more depressions or grooves in an internal wall of the drum. In another example, the article guide comprises a combination of protrusions or grooves. Such an article guide may be comprised in other examples hereby described.

FIG. 4 illustrates another example system 400 according to this disclosure. The system comprises dispenser 401, drum 402 rotatable around drum rotation axis 403 making in this example an angle 404 of about 85 degrees with a direction of gravity 405. In the system 400 according to FIG. 4, the collection element 406 is located adjacent to a drumhead, in this case a drumhead situated relatively higher than an opposite drumhead. The collection element may collect a detergent article such as detergent article 4110 from the detergent articles 411 contained in drum 402. The collection element may rotate in order to lift and release detergent article 4110 onto refilling area 408. In this example, the drum comprises an article guide 410 for guiding the articles towards the collection element 406. In this example, the article guide comprises a helical article guide which guides the detergent articles towards the collection element in the manner of an Archimedes screw compensating the force of gravity and fomenting an uphill movement of the detergent articles in the drum. Such helical guide may be continuous or may comprise a plurality of different sections. Such helical guide may comprise one or more protrusion, one or more depression or groves, or a combination of one or more depressions or groves in a drum wall. Different article guides may be combined in a same system, using different drum shapes, different collection element configurations, different refilling area configurations, different detergent articles or different drum inclination angles corresponding to the angle between gravity and the drum rotation axis.

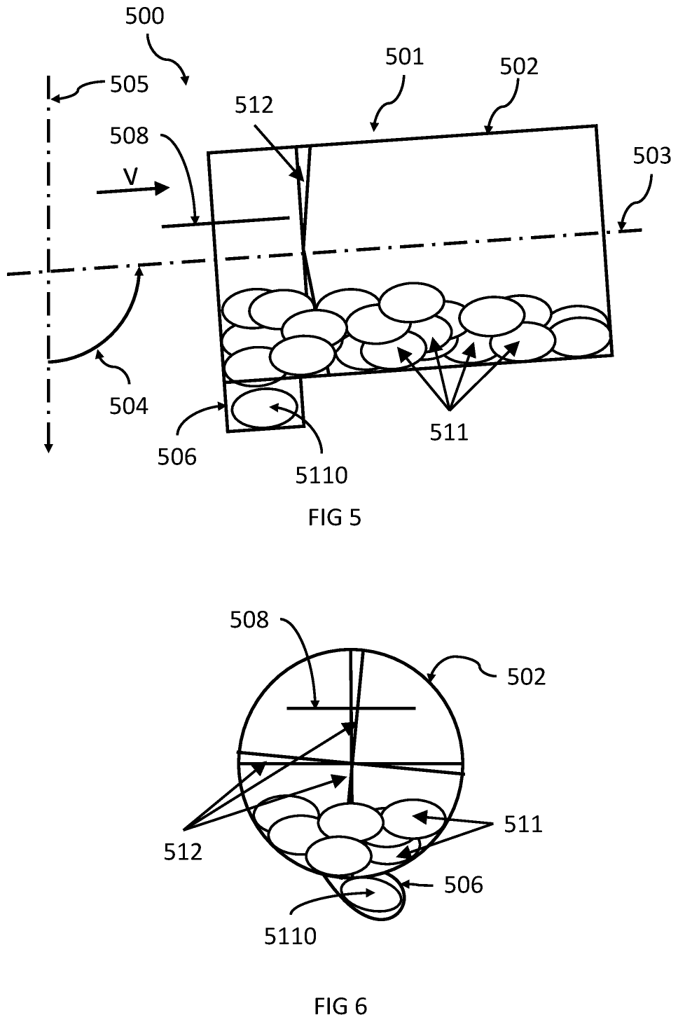

FIGS. 5 and 6 illustrate another example system 500 according to this disclosure. FIG. 6 represents the system 500 viewed following direction V illustrated in FIG. 5. The system comprises dispenser 501, drum 502 rotatable around drum rotation axis 503 making in this example an angle 504 of about 95 degrees with a direction of gravity 505, direction V being parallel to drum rotation axis 503. In the system 500 according to FIGS. 5 and 6, the collection element 506 is located adjacent to a drumhead, in this case a drumhead situated relatively lower than an opposite drumhead. The collection element may collect a detergent article such as detergent article 5110 from the detergent articles 511 contained in drum 502. The collection element may rotate in order to lift and release detergent article 5110 onto refilling area 508. In this example, the drum comprises a paddle 512 proximate to the collection element, the paddle being in this case a paddle of a set of paddles, whereby the paddles of the set of paddles are evenly distributed around a perimeter of the drum and extend radially from a centre of the drum to a drum shell. A dispenser may in some examples comprise a single paddle. Each paddle may comprise a leading edge and a trailing edge, the leading edge being in some examples rounded to avoid damaging detergent articles. A paddle or set of paddle may rotate together with the drum to move the detergent articles and thereby direct such detergent articles towards the collection element while avoiding jamming. In some examples, the paddle is rotating together with and at the same angular speed as the drum, such paddle being static compared to the drum structure. In other example the paddle is configured to rotate at a speed different from the drum, for example to foment additional movement of the detergent articles. In some examples, the paddle is configured to rotate in the same direction as the direction of the drum, for example to avoid excessive movement of the detergent articles. In some examples, the paddle is configured to rotate in a direction opposite to the direction of rotation of the drum, for example to foment further movement of the detergent articles.

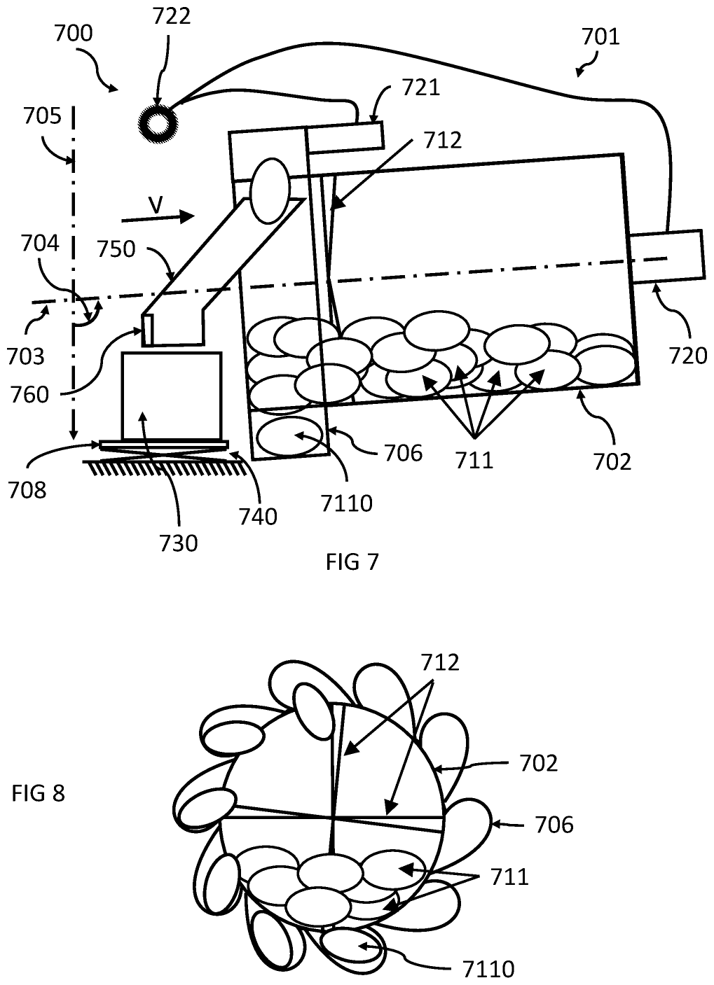

FIGS. 7 and 8 illustrate another example system 700 according to this disclosure. FIG. 8 represents the system 700 viewed following direction V illustrated in FIG. 7. Some elements such as the refilling area are not represented in FIG. 8 in order to facilitate readability of FIG. 8. The system comprises dispenser 701, drum 702 rotatable around drum rotation axis 703 making in this example an angle 704 of about 95 degrees with a direction of gravity 705, direction V being parallel to drum rotation axis 703. In the system 700 according to FIGS. 7 and 8, the collection element 706 is located adjacent to a drumhead, in this case a drumhead situated relatively lower than an opposite drumhead. The collection element may collect a detergent article such as detergent article 7110 from the detergent articles 711 contained in drum 702. The collection element may rotate in order to lift and release detergent article 7110 so the detergent article is directed towards refilling area 708. In this example, the dispenser 701 comprises paddles 712.

In the example illustrated in FIGS. 7 and 8, the drum 702 comprises a rotation mechanism 720-721, the rotation mechanism 720-721 operating a rotation of the drum and of the collection element. In this example, the rotation mechanism comprises a first motor 720 for rotating the drum and a second motor 721 for rotating the collection element. The rotation mechanism may comprise one or more elements such as gears, pulleys or belts. The rotation mechanism may comprise a single motor rotating both the drum and the collection element. The rotation mechanism may be configured to be operated by a motor or may be configured to be operated by human muscular force, for example in order to save energy or be operable without energy supply. The rotation mechanism may be configured to be operated by a combination of human muscular force and of a motor. Human muscular force may be provided by a lever comprised in the system according to this disclosure. Human muscular force may be provided by loading a spring comprised in the system according to this disclosure. The rotation mechanism may comprise an actuator such as actuator 722. An actuator such as actuator 722 may be connected to one or more motors by way of cables or in a wireless manner.

In the example illustrated in FIGS. 7 and 8 the collection element comprises a plurality of scoops evenly distributed around a perimeter of the drum as visible for example in FIG. 8, each scoop permitting collecting and lifting at least one article as each scoop rotates from the collecting position to the releasing position, whereby each scoop comprises an aperture preferably facing the drum rotation axis, whereby each scoop defines a cavity, the cavity preferably corresponding to a single article, and whereby each scoop comprises a scooping surface, the scooping surface being preferably inclined towards the scoop aperture to facilitate releasing the collected and lifted article when the scoop is in the releasing position. In this example, the collection element comprises 10 scoops. It should be understood that a plurality of scoops may be provided in other examples according to this disclosure. A collection element comprising a plurality of scoops permits accelerating the dispensing of detergent articles. A collection element comprising a plurality of scoops operates as a mill, the scoops acting as buckets, each scoop lifting a respective one of more detergent article to the releasing position. In an example as represented in FIGS. 7 and 8, while operating the dispenser comprises about half of its scoop comprising one or more detergent articles and lifting such articles from the collecting position to the releasing position, about half of its scoop being empty from detergent articles and returning from the releasing position back to the collecting position. In some examples, the dispenser dispenses more than one detergent article per second when in operation.

In the example illustrated in FIGS. 7 and 8, the system 700 comprises a chute 750 fixedly positioned to direct the collected and lifted article from the scoop to the refilling area, a top end of the chute facing a scoop aperture when the scoop is in the releasing position, a bottom end of the chute facing the refilling area. In some examples the chute is tubular, thereby protecting the detergent access from an external interaction while being directed towards the refilling area. In some examples, the chute is toboggan like. In some examples, the chute comprises a transparent or translucent section so a user may be in a position to observe that the dispenser is functioning, or be in a position to observe that the dispenser is malfunctioning. Other elements, sections or parts of the dispenser may be transparent or translucent to provide such advantage. In particular, the drum may comprise a transparent or translucent window in order to evaluate whether the drum should be refilled with detergent articles or not. Such visibility also may provide information as to the nature of the detergent articles being dispensed, for example permitting differentiating laundry detergent unit doses from dishwashing detergent unit doses through color-coding or shape of the unit doses. Such advantages may be provided in systems which are not equipped with a chute. In some examples, the chute has a minimum cross section 150% larger than a maximum cross section of a detergent article, in order to avoid a jam of detergent articles in the chute.

Various elements hereby described such as the drum, paddle, collecting element, article guide or chute may be made of metal, plastic, cardboard or glass material.

In the example illustrated in FIGS. 7 and 8, the system 700 comprises a removable container 730 to be refilled, the removable container being placed at the refilling area 708. The container to be refilled comprises a container cavity. In some examples, the cavity is configured to contain between 10 and 20 detergent articles. In some examples, the cavity is configured to contain between 20 and 30 detergent articles. In some examples, the cavity is configured to contain between 30 and 40 detergent articles. In some examples, the cavity is configured to contain between 40 and 50 detergent articles. In some examples, the cavity is configured to contain more than 50 detergent articles. The container to be refilled may comprise a placement element matching a receiving element affixed to the refilling area, in order to ensure appropriate placement of the container at the refilling area, in order to avoid detergent articles falling outside of the container to be refilled. The placement element and the receiving element may comprise one or more of a rib, a groove matching the rib, a recess, a protrusion matching the recess, a profile and a matching profile, a pin and matching pinhole or other matching elements. In some examples the dispenser comprises a locking system, the locking system preventing use of the dispenser if a container to be refilled is not detected as being placed at the refilling area. The locking system may comprise a locking pin preventing rotation of one or more of the elements of the system.

In the example illustrated in FIGS. 7 and 8, the dispenser comprises a container sensor 740 at the refilling area. In this example, the sensor is a weight sensor such as a balance. Such a sensor may for example not only detect whether a container is present at the refilling area of not, but may also detect or estimate whether such container contains detergent articles, and even how many detergent articles the container contains, thereby facilitating the refilling process. The container sensor also may comprise sensors different from a weight sensor, such as, for example, an optical sensor. The container sensor may be connected to an electronic control unit of the system according to this disclosure. Such an electronic control unit also may be connected to the rotation mechanism.

In the example illustrated in FIGS. 7 and 8, the system comprises a counter 760, the counter counting a number of articles directed to the refilling area. In this example, the counter 760 is an optical sensor which is activated each time a detergent article passes through the chute from the releasing position to the refilling area. Such sensor may comprise one or more of an optical sensor, a capacity sensor or a weight sensor. It should be noted that the container sensor 740 may operate both as a container sensor and as a counter. The counter may be connected to an electronic control unit of the system according to this disclosure. Such control unit may permit automating the refilling of a container to be refilled by a dispenser according to this disclosure. The counter may prevent overfilling or under filling the container to be refilled.

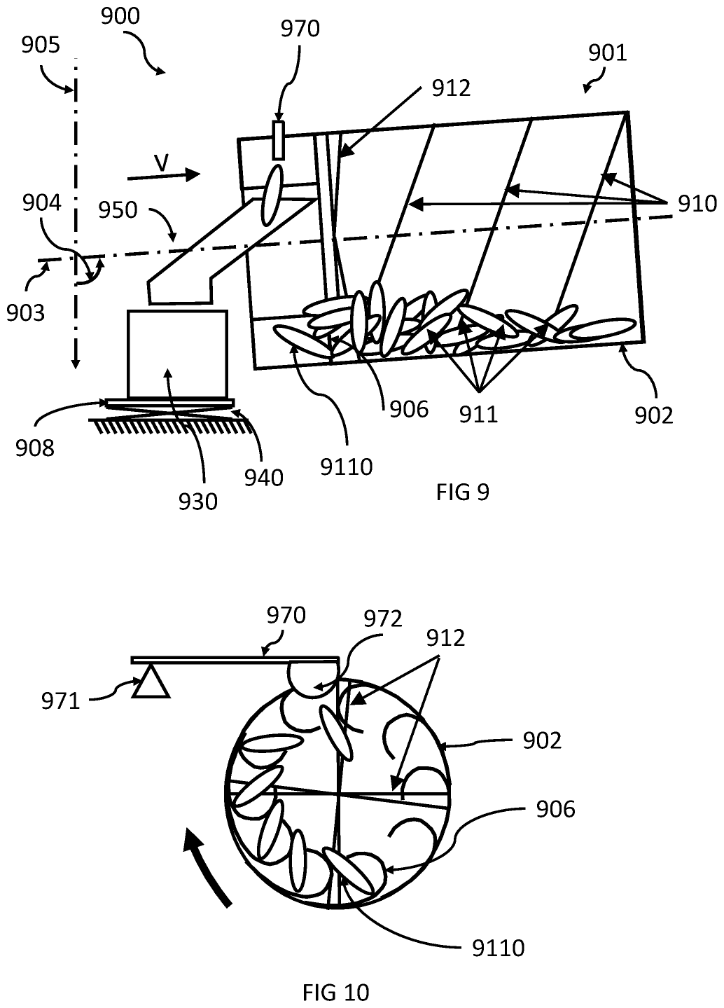

FIGS. 9 and 10 illustrate another example system 900 according to this disclosure. FIG. 10 represents the system 900 viewed following direction V illustrated in FIG. 9. Some elements such as the refilling area are not represented in FIG. 10 in order to facilitate readability of FIG. 10. The system comprises dispenser 901, drum 902 rotatable around drum rotation axis 903 making in this example an angle 904 of about 95 degrees with a direction of gravity 905, direction V being parallel to drum rotation axis 903. In the system 900 according to FIGS. 9 and 10, the collection element 906 is located adjacent to a drumhead, in this case a drumhead situated relatively lower than an opposite drumhead. The collection element may collect a detergent article such as detergent article 9110 from the detergent articles 911 contained in drum 902. The collection element may rotate in order to lift and release detergent article 9110 so the detergent article is directed towards refilling area 908. In this example, the dispenser 901 comprises paddles 912 and a helical article guide 910.

In the example illustrated in FIGS. 9 and 10 the collection element comprises a plurality of scoops evenly distributed around a perimeter of the drum as visible for example in FIG. 10.

In the example illustrated in FIGS. 9 and 10, the system 900 comprises a chute 950 fixedly positioned to direct the collected and lifted article from the scoop to the refilling area.

In the example illustrated in FIGS. 9 and 10, the system 900 comprises a removable container 930 to be refilled, the removable container being placed at the refilling area 908.

In the example illustrated in FIGS. 9 and 10, the dispenser comprises a container sensor 940 at the refilling area. In this example, the sensor is a weight sensor such as a balance.

In the example illustrated in FIGS. 9 and 10, the system comprising an ejection arm 970, the ejection arm interacting with the scoop when the scoop is in the releasing position, whereby the ejection arm. In this example, the ejection arm operates by penetrating any scoop passing through the releasing position, each scoop comprising a slot matching the ejection arm and permitting penetration of the ejection arm through the slot to eject a collected and lifted article to be released towards the refilling area. In other examples, the ejection arm may operate by interacting with the scoop by colliding with the scoop. Such ejection arm may in some examples be supported by a pivot 971 and may have a distal end 972 penetrating each scoop, the distal end having a rounded profile to avoid breaking or rupturing a detergent article. The ejection arm may be engaged to a spring contributing to pushing a detergent out of a spoon for release. An ejection arm is particularly fitted to ensure dispensing of detergent articles being water soluble, due to an inherent stickiness of such detergent articles. An ejection arm is particularly fitted to ensure dispensing of detergent articles when the scoop or scoops define an internal cavity of a volume relatively close to a volume occupied by a detergent article. In some examples, each scoop defines an internal cavity having a volume of less than 180% of the volume occupied by a single detergent article. In some examples, each scoop defines an internal cavity having a volume of less than 150% of the volume occupied by a single detergent article. In some examples, each scoop defines an internal cavity having a volume of more than 100% of the volume occupied by a single detergent article. In some examples, each scoop defines an internal cavity having a volume of more than 120% of the volume occupied by a single detergent article.

While different examples have been described in the above Figures as comprising different elements in order to maintain readability of the Figures, a preferred example may comprise a cylinder drum having a drum rotation axis at 90 degrees from gravity as well as a chute, a paddle and a helical article guides. Such preferred example may comprise a collection element located adjacent to a drumhead, the collecting element comprising multiple scoops evenly distributed around a circumference of the drum, each scoop comprising a slot. Such preferred embodiment may further comprise an ejection arm penetrating each scoop through the slot when the scoop is in the releasing position.

In some examples, the container to be refilled comprises a label, the label comprising information related to the detergent articles and/or to the container, whereby such label may for example be scanned by an optical sensor comprised in the dispenser according to this disclosure in order to direct refilling based on instructions defined by an electronic control unit of the system based on the information comprised on the label. Such information may be for example in the form of a bar code or bi-dimensional code (bidi). In some examples, the dispenser further comprises a label printer, the label printer being configured to print a label comprising information related to the detergent article, such as safety or regulatory information related to the detergent article the label being suitable for being applied, for example by glue, to the container to be refilled. In some examples, the refilling container comprises an indication as to a refilling container capacity corresponding to a number of articles with which the respective refilling container may be refilled, whereby such number of articles may be scanned at the dispenser according to this disclosure, an/or may be preselected at the dispenser according to this disclosure.

In some examples the drum contains at least 100 detergent articles when full. In some examples, the drum contains at least 200 detergent articles when full. In some examples, the drum contains at least 400 detergent articles when full. In some examples, the drum contains at least 600 detergent articles when full. In some examples, the drum contains at least 800 detergent articles when full. In some examples, the drum contains at least 1000 detergent articles when full. This permits refilling of a satisfactory number of containers to be refilled without running out of detergent articles. In some examples, the drum defines an internal volume for containing the detergent articles, whereby the internal volume is at least 50% empty from detergent articles when operating and when full. In some examples, the drum defines an internal volume for containing the detergent articles, whereby the internal volume is at least 60% empty from detergent articles when operating. In some examples, the drum defines an internal volume for containing the detergent articles, whereby the internal volume is at least 70% empty from detergent articles when operating. Maintaining a relatively high percentage of the drum internal volume empty permits avoiding jamming and foments free flow of detergent articles within the system when in operation or even when full (full meaning in this description that the dispenser is at maximum capacity, even if the internal volume is partially empty). During operation, the number of articles contained in the drum may drop below 100 articles for example. The dispenser may in some examples keep functioning until emptied from articles. In some examples, the drum contains at most 1000 detergent articles when full. Having such a maximum capacity may facilitate housing of the dispenser in a point of sale having space restrictions. Such a maximum capacity may also avoid significant efforts due to refilling of the dispenser, such efforts being due to the combined weight of a large number of articles. In some examples, the drum contains less than 20 kilograms of articles when full. In some examples, the dispenser is refilled at most once a day. In some examples, the dispenser may be connected to an auto-replenishment system or refilling system, such system refilling or replenishing the dispenser with articles when the dispenser contains less articles than a predetermined threshold, the replenishing or refilling taking place for example using boxes or cartridges comprising articles.

In some examples, the drum may be periodically refilled by an operator. Refilling of the drum may take place for example through an opening at a drumhead. In an example, the collecting element is at a drumhead and the drum refilling opening at an opposite drumhead. In some examples, refilling of the drum may take place using a drum refilling cartridge which may gradually or entirely release detergent articles in the drum. Such cartridges may be dispensable cartridges, or may be reusable cartridges, which may be cleaned and refilled by a detergent articles manufacturer.

In some examples, various systems according to this disclosure may be provided, for example in a side by side configuration, in order to provide refilling simultaneously for various consumers, and/or in order to offer refilling of detergent articles having different characteristics. In some examples, such multiple systems may build an array of systems according to this disclosure. In some examples, such plurality of systems may be operated by a same single operating system. In some examples, a plurality of systems according to this invention share a common chute and common refilling area. In some examples, a user may select, using the operating system, a type of detergent articles for refill.

In some examples the articles are unit dose articles containing a liquid detergent, a granular detergent, or a combination of a liquid detergent and of a granular detergent, and whereby each unit dose article is preferably a flexible unit dose article, more preferably a flexible water soluble unit dose article. The system according to the invention is indeed particularly well suited to dispensing such articles.

In some examples the article is a water-soluble unit dose article which comprises at least one water-soluble film orientated to create at least one-unit dose internal compartment, wherein the at least one-unit dose internal compartment comprises a detergent composition. The water-soluble film and the detergent composition are described in more detail below. In some examples the container to be refilled comprises at least one water-soluble unit dose article, in some cases at least two water-soluble unit dose articles, in some cases at least 10 water-soluble unit dose articles, in some cases at least 20 water-soluble unit dose articles, in some cases at least 30 water-soluble unit dose articles, in some cases at least 40 water-soluble unit dose articles, in some cases at least 45 water-soluble unit dose articles. A water-soluble unit dose article is in some examples in the form of a pouch. A water-soluble unit dose article comprises in some examples a unitary dose of a composition as a volume sufficient to provide a benefit in an end application. The water-soluble unit dose article comprises in some examples one water-soluble film shaped such that the unit-dose article comprises at least one internal compartment surrounded by the water-soluble film. The at least one compartment comprises a cleaning composition. The water-soluble film is sealed such that the cleaning composition does not leak out of the compartment during storage. However, upon addition of the water-soluble unit dose article to water, the water-soluble film dissolves and releases the contents of the internal compartment into the wash liquor. The unit dose article may comprise more than one compartment, at least two compartments, or at least three compartments, or at least four compartments, or even at least five compartments. The compartments may be arranged in superposed orientation, i.e. one positioned on top of the other. Alternatively, the compartments may be positioned in a side-by-side orientation, i.e. one orientated next to the other. The compartments may be orientated in a ‘tire and rim’ arrangement, i.e. a first compartment is positioned next to a second compartment, but the first compartment at least partially surrounds the second compartment, but does not completely enclose the second compartment. Alternatively, one compartment may be completely enclosed within another compartment. In some examples the unit dose article comprises at least two compartments, one of the compartments being smaller than the other compartment. In some examples the unit dose article comprises at least three compartments, two of the compartments may be smaller than the third compartment, and in some examples the smaller compartments being superposed on the larger compartment. The superposed compartments are in some examples orientated side-by-side. In some examples each individual unit dose article may have a weight of between 10 g and 40 g, or even between 15 g and 35 g. The water soluble film may be soluble or dispersible in water. Prior to be being formed into a unit dose article, the water-soluble film has in some examples a thickness of from 20 to 150 micron, in other examples 35 to 125 micron, in further examples 50 to 110 micron, in yet further examples about 76 micron. Example water soluble film materials comprise polymeric materials. The film material can, for example, be obtained by casting, blow-molding, extrusion or blown extrusion of the polymeric material. In some examples, the water-soluble film comprises polyvinyl alcohol polymer or copolymer, for example a blend of polyvinylalcohol polymers and/or polyvinylalcohol copolymers, for example selected from sulphonated and carboxylated anionic polyvinylalcohol copolymers especially carboxylated anionic polyvinylalcohol copolymers, for example a blend of a polyvinylalcohol homopolymer and a carboxylated anionic polyvinylalcohol copolymer. In some examples water soluble films are those supplied by Monosol under the trade references M8630, M8900, M8779, M8310. In some examples the film may be opaque, transparent or translucent. The film may comprise a printed area. The area of print may be achieved using techniques such as flexographic printing or inkjet printing. The film may comprise an aversive agent, for example a bittering agent. Suitable bittering agents include, but are not limited to, naringin, sucrose octaacetate, quinine hydrochloride, denatonium benzoate, or mixtures thereof. Example levels of aversive agent include, but are not limited to, 1 to 5000 ppm, 100 to 2500 ppm, or 250 to 2000 ppm. The water-soluble film or water-soluble unit dose article or both may be coated with a lubricating agent. In some examples, the lubricating agent is selected from talc, zinc oxide, silicas, siloxanes, zeolites, silicic acid, alumina, sodium sulphate, potassium sulphate, calcium carbonate, magnesium carbonate, sodium citrate, sodium tripolyphosphate, potassium citrate, potassium tripolyphosphate, calcium stearate, zinc stearate, magnesium stearate, starch, modified starches, clay, kaolin, gypsum, cyclodextrins or mixtures thereof.

In some examples the container to be refilled comprises a first part, wherein the first part comprises a first compartment in which the at least one water-soluble unit dose article is contained. In some examples the first compartment comprises at least two water-soluble unit dose articles. The first compartment may comprise between 1 and 80 water-soluble unit dose articles, between 1 and 60 water-soluble unit dose articles, between 1 and 40 water-soluble unit dose articles, or between 1 and 20 water-soluble unit dose articles. The volume of the first compartment may be between 500 ml and 5000 ml, in some examples between 800 ml and 4000 ml.

In some examples the detergent product comprises a detergent composition. The detergent composition may be a laundry detergent composition, an automatic dishwashing composition, a hard surface cleaning composition, or a combination thereof. The detergent composition may comprise a solid, a liquid or a mixture thereof. The term liquid includes a gel, a solution, a dispersion, a paste, or a mixture thereof. The solid may be a powder. By powder we herein mean that the detergent composition may comprise solid particulates or may be a single homogenous solid. In some examples, the powder detergent composition comprises particles. This means that the powder detergent composition comprises individual solid particles as opposed to the solid being a single homogenous solid. The particles may be free-flowing or may be compacted. A laundry detergent composition can be used in a fabric hand wash operation or may be used in an automatic machine fabric wash operation, for example in an automatic machine fabric wash operation. Example laundry detergent compositions comprise a non-soap surfactant, wherein the non-soap surfactant comprises an anionic non-soap surfactant and a non-ionic surfactant. In some examples, the laundry detergent composition comprises between 10% and 60%, or between 20% and 55% by weight of the laundry detergent composition of the non-soap surfactant. Example weight ratio of non-soap anionic surfactant to nonionic surfactant are from 1:1 to 20:1, from 1.5:1 to 17.5:1, from 2:1 to 15:1, or from 2.5:1 to 13:1. Example non-soap anionic surfactants comprises linear alkylbenzene sulphonate, alkyl sulphate or a mixture thereof. Example weight ratio of linear alkylbenzene sulphonate to alkyl sulphate are from 1:2 to 9:1, from 1:1 to 7:1, from 1:1 to 5:1, or from 1:1 to 4:1. Example linear alkylbenzene sulphonates are C10-C16 alkyl benzene sulfonic acids, or C11-C14 alkyl benzene sulfonic acids. By ‘linear’, we herein mean the alkyl group is linear. Example alkyl sulphate anionic surfactant may comprise alkoxylated alkyl sulphate or non-alkoxylated alkyl sulphate or a mixture thereof. Example alkoxylated alkyl sulphate anionic surfactant comprise an ethoxylated alkyl sulphate anionic surfactant. Example alkyl sulphate anionic surfactant may comprise an ethoxylated alkyl sulphate anionic surfactant with a mol average degree of ethoxylation from 1 to 5, from 1 to 3, or from 2 to 3. Example alkyl sulphate anionic surfactant may comprise a non-ethoxylated alkyl sulphate and an ethoxylated alkyl sulphate wherein the mol average degree of ethoxylation of the alkyl sulphate anionic surfactant is from 1 to 5, from 1 to 3, or from 2 to 3. Example alkyl fraction of the alkyl sulphate anionic surfactant are derived from fatty alcohols, oxo-synthesized alcohols, Guerbet alcohols, or mixtures thereof. In some examples, the laundry detergent composition comprises between 10% and 50%, between 15% and 45%, between 20% and 40%, or between 30% and 40% by weight of the laundry detergent composition of the non-soap anionic surfactant. In some examples, the non-ionic surfactant is selected from alcohol alkoxylate, an oxo-synthesized alcohol alkoxylate, Guerbet alcohol alkoxylates, alkyl phenol alcohol alkoxylates, or a mixture thereof. In some examples, the laundry detergent composition comprises between 0.01% and 10%, between 0.01% and 8%, between 0.1% and 6%, or between 0.15% and 5% by weight of the liquid laundry detergent composition of a non-ionic surfactant. In some examples, the laundry detergent composition comprises between 1.5% and 20%, between 2% and 15%, between 3% and 10%, or between 4% and 8% by weight of the laundry detergent composition of soap, in some examples a fatty acid salt, in some examples an amine neutralized fatty acid salt, wherein in some examples the amine is an alkanolamine for example selected from monoethanolamine, diethanolamine, triethanolamine or a mixture thereof, in some examples monoethanolamine. In some examples, the laundry detergent composition is a liquid laundry detergent composition. In some examples the liquid laundry detergent composition comprises less than 15%, or less than 12% by weight of the liquid laundry detergent composition of water. In some examples, the laundry detergent composition is a liquid laundry detergent composition comprising a non-aqueous solvent selected from 1,2-propanediol, dipropylene glycol, tripropyleneglycol, glycerol, sorbitol, polyethylene glycol or a mixture thereof. In some examples, the liquid laundry detergent composition comprises between 10% and 40%, or between 15% and 30% by weight of the liquid laundry detergent composition of the non-aqueous solvent. In some examples, the laundry detergent composition comprises a perfume. In some examples, the laundry detergent composition comprises an adjunct ingredient selected from the group comprising builders including enzymes, citrate, bleach, bleach catalyst, dye, hueing dye, brightener, cleaning polymers including alkoxylated polyamines and polyethyleneimines, soil release polymer, surfactant, solvent, dye transfer inhibitors, chelant, encapsulated perfume, polycarboxylates, structurant, pH trimming agents, and mixtures thereof. In some examples, the laundry detergent composition has a pH between 6 and 10, between 6.5 and 8.9, or between 7 and 8, wherein the pH of the laundry detergent composition is measured as a 10% product concentration in demineralized water at 20° C. When liquid, the laundry detergent composition may be Newtonian or non-Newtonian. In some examples, the liquid laundry detergent composition is non-Newtonian. Without wishing to be bound by theory, a non-Newtonian liquid has properties that differ from those of a Newtonian liquid, more specifically, the viscosity of non-Newtonian liquids is dependent on shear rate, while a Newtonian liquid has a constant viscosity independent of the applied shear rate. The decreased viscosity upon shear application for non-Newtonian liquids is thought to further facilitate liquid detergent dissolution. The liquid laundry detergent composition described herein can have any suitable viscosity depending on factors such as formulated ingredients and purpose of the composition.

In some examples, each article is an article comprising an external flange area, the external flange area defining a maximum cross section, such maximum cross section being surrounded by the external flange area and intersecting an internal volume of the detergent article comprising the detergent, the article further comprising a minimum cross section area intersecting a geometric centre of the maximum cross section, a ratio between the maximum cross section area and the minimum cross section area being of less than 3, preferably less than 2. In some examples the article has an ellipsoid or a spheroid shape. One should note that the flange area may include a seal portion which may not define an internal volume comprising detergent, whereby the maximum cross section is of less than a full cross section comprising such seal portion.

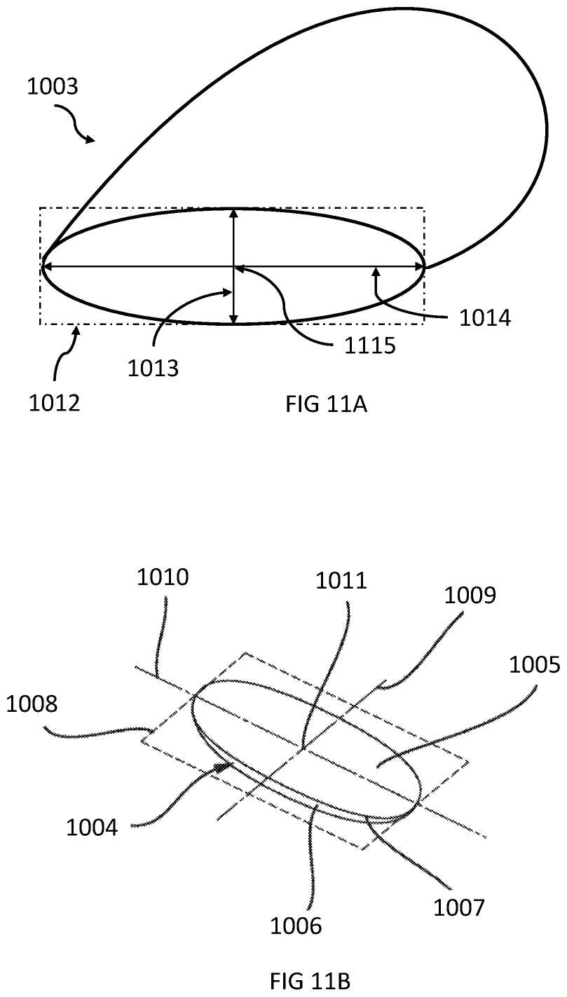

In some examples as illustrated on FIGS. 11A and 11B, a scoop 1003 as per this disclosure comprises an opening or scoop aperture and an internal compartment or cavity, whereby one or more than one articles may be held. In some examples, the article 1004 comprises at least a first film 1005 and second film 1006 wherein the first film 1005 and second film 1006 are sealed together forming a seal area 1007 wherein said seal area 1007 runs around the periphery of the pouch defining a first two dimensional cross-sectional plane 1008. The unit dose article 1004 comprises a first smallest cross-sectional axis 1009 and a first largest cross sectional axis 1010 wherein the first smallest 1009 and first largest cross-sectional axis 1010 cross one another through a geometrical centre point 1011 of the first two dimensional cross-sectional plane 1008. The opening or aperture of the scoop 1003 comprises a second two-dimensional cross-sectional plane 1012 which may be parallel to the first two-dimensional cross-sectional plane 108 as the article enters the spoon through the aperture. The spoon aperture comprises a second smallest cross-sectional axis 1013 and a second largest cross sectional axis 1014 wherein the second smallest 1013 and second largest cross-sectional axis 1014 cross one another through a geometrical centre point 1015 of the second two dimensional cross-sectional plane 1012. The ratio of the first largest cross-sectional dimension 1010 to the second largest cross-sectional dimension 1014 is from 1:1 to 1:1.8, preferably from 1:1.1 to 1:1.6, more preferably from 1:1.2 to 1:1.5 and the first smallest cross-sectional dimension 1009 to the second smallest cross-sectional dimension 1013 of the scoop aperture is from 1:1 to 1:1.8, preferably from 1:1.1 to 1:1.6, more preferably from 1:1.2 to 1:1.5. In case of the article comprising a flange area, such flange area should be excluded from cross sectional dimensions. Such flange is excluded from such dimensions due to the fact that such flange may be particularly flexible and correspond to a two dimensional film plane which may not prevent entering the scoop.

In some examples, an article comprises an additional characteristic cross-sectional dimension along a direction orthogonal to both the first largest cross-sectional axis 1010 and the first smallest cross sectional axis 1009, the additional characteristic dimension passing through the geometrical centre point 1011 of the first two dimensional cross-sectional plane 1008. The ratio of the additional characteristic cross-sectional dimension to a depth dimension of the spoon is from 1:1 to 1:1.8, preferably from 1:1.1 to 1:1.6, more preferably from 1:1.2 to 1:1.5. The depth of the spoon may be measured along a direction orthogonal to both the second smallest cross-sectional axis 1013 and the second largest cross sectional axis 1014 and passing through the geometrical centre point 1015 of the second two dimensional cross-sectional plane 1012. Again, in case of the article comprising a flange area, such flange area should be excluded from cross sectional dimensions.

In some examples, considering a given article in a static situation without being submitted to a compression, the article has a first largest cross-sectional dimension, a first smallest cross sectional dimension and an additional characteristic dimension as defined above. In preferred examples, the ratio between the smallest and the largest dimensions of such three dimensions is from 1:1 to 1:2, preferably 1:1 to 1:1.75, more preferably 1:1 to 1:1.5. It was indeed found that the dispensing of articles was improved as articles had a shape tending towards a sphere.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes

What is claimed is:

1. A system comprising articles and a dispenser for the articles, the articles being detergent articles, the dispenser comprising:
a drum containing the articles, the drum being rotatable around a drum rotation axis making an angle of at least about 75 degrees and of less than about 135 degrees with the direction of gravity;
a collection element, the collection element being rotatable around the drum rotation axis, the collection element comprising a scoop, the scoop permitting collecting and lifting at least one article as the scoop rotates from a collecting position to a releasing position; and
a refilling area, whereby an article collected and lifted by the scoop is directed from the releasing position to the refilling area.

2. The system according to claims, wherein the drum has a cylindrical shape, a barrel shape, a funnel shape, or a conical shape.

3. The system according to claim 1, whereby a drum shell of the drum comprises an article guide for guiding the articles towards the collection element.

4. The system according to claim 3, wherein the article guide is a helical article guide.

5. The system according to claim 1, whereby the drum comprises a paddle proximate to the collection element.

6. The system according to claim 5, wherein the paddle is a paddle of a set of paddles, whereby the paddles of the set of paddles are evenly distributed around a perimeter of the drum and extend radially from a center of the drum to a drum shell.

7. The system according to claim 1, wherein the system comprises a counter, the counter capable of counting a number of articles directed to the refilling area.

8. The system according to claim 7, wherein the counter comprises one or more of a member selected from the group consisting of an optical sensor, a capacity sensor, and a weight sensor.

9. The system according to claim 1, wherein the system comprises an ejection arm, the ejection arm interacting with the scoop when the scoop is in the releasing position.

10. The system according to claim 9, wherein the ejection arm operates by one or more of:
penetrating any scoop passing through the releasing position, each scoop comprising a slot matching the ejection arm and permitting penetration of the ejection arm through the slot to eject a collected and lifted article to be released towards the refilling area; or
interacting with the scoop by colliding with the scoop.

11. The system according to claim 1, the dispenser comprising a rotation mechanism, the rotation mechanism operating a rotation of the drum and of the collection element.

12. The system according to claim 1, whereby the collection element is configured to rotate at the same speed as the drum.

13. The system according to claim 1, whereby the collection element is configured to rotate faster than the drum, the collection element being a part that is separate from the drum, the collection element being engaged with the drum.

14. A system according to claim 1, whereby the articles are unit dose articles containing a liquid detergent, a granular detergent, or a combination of a liquid detergent and of a granular detergent.

15. A system according to claim 14, whereby each article is an article comprising an external flange area, the external flange area defining a maximum cross section, such maximum cross section being surrounded by the external flange area and intersecting an internal volume of the detergent article comprising the detergent, the article further comprising a minimum cross section area intersecting a geometric center of the maximum cross section, a ratio between the maximum cross section area and the minimum cross section area being of less than about 3.

16. The system according to claim 1, the system further comprising a removable container to be refilled, the removable container being placed at the refilling area.

17. The system according to claim 1, the drum rotation axis making an angle of at least about 80 degrees and of less than about 110 degrees with the direction of gravity.

18. The system according to claim 1, the collection element being adjacent to a drum opening at a drumhead.

19. The system according to claim 1, the system comprising a chute fixedly positioned to direct the collected and lifted article from the scoop to the refilling area, a top end of the chute facing a scoop aperture when the scoop is in the releasing position, a bottom end of the chute facing the refilling area.

20. The system according to claim 1, wherein the collection element comprises a plurality of scoops evenly distributed around a perimeter of the drum, each scoop permitting collecting and lifting at least one article as each scoop rotates from the collecting position to the releasing position, whereby each scoop comprises an aperture facing the drum rotation axis, whereby each scoop defines a cavity, the cavity corresponding to a single article, and whereby each scoop comprises a scooping surface, the scooping surface being inclined towards the scoop aperture to facilitate releasing the collected and lifted article when the scoop is in the releasing position.
